(19) United States
(12) Patent Application Publication
(10) Pub. No.: US 2020/0232691 A1
(43) Pub. Date: Jul. 23, 2020

(54) THROTTLING DISTRIBUTION ASSEMBLY AND REFRIGERATION SYSTEM

(71) Applicant: Carrier Corporation, Palm Beach Gardens, FL (US)

(72) Inventors: Bob Zhao, Shanghai (CN); Yan Gu, Shanghai (CN)

(21) Appl. No.: 16/649,032

(22) PCT Filed: Sep. 25, 2018
(86) PCT No.: PCT/US2018/052578

§ 371 Date: Mar. 19, 2020

(30) Foreign Application Priority Data
Sep. 26, 2017 (CN) 201710880991.0

(51) Int. Cl. F25B 41/06; F25B 5/02; F16K 11/07

(52) U.S. Cl. CPC F25B 41/062; F25B 39/028; F16K 11/07; F25B 5/02

(57) ABSTRACT

A throttling and distributing component includes: a main body extending from a first end to a second end, wherein a fluid enters the main body from the first end; a regulator having a valve rod, wherein the valve rod passes through the second end and extends into the main body; one or more openings disposed on a sidewall of the main body, each opening being in fluid communication with a plurality of branches extending from the main body respectively; and a piston attached to the valve rod. The regulator is configured to adjust the position of the piston in the main body by using the valve rod, so as to selectively cover at least a part of each opening. The throttling and distributing component of the present invention is advantageous in a simple structure, reliable running, and can complete a throttling operation while distributing a refrigerant.

### TECHNICAL FIELD

The present invention relates to the field of refrigeration or air conditioning, and more particularly, to a throttling and distributing component, which functions as an expansion valve and a distributor at the same time. The present invention further relates to a refrigerating system including the throttling and distributing component.

### BACKGROUND ART

It is known that in a refrigerating system, an operating liquid (e.g., a refrigerant) generally needs to be transported from a condenser to an evaporator. In this process, the operating fluid starting from the condenser first passes through a throttling member (e.g., an expansion valve) to form two phases of gas and liquid. Then, the gas-liquid two-phase operating liquid passes through a distribution member (e.g., a distributor), and then is divided into several flows of the operating liquid and transported to respective evaporators or respective evaporator passages.

However, during the distribution, the operating liquid has been divided into two phases of gas and liquid, easily causing problems such as uneven distribution. The uneven distribution of the operating liquid may cause uneven flux of downstream evaporators, thus causing problems of reduced efficiency of the evaporators and instability of the refrigerating system.

Therefore, there are constant requirements on improving the throttling and distributing component and the refrigerating system.

### SUMMARY OF THE INVENTION

An objective of the present invention is to provide a throttling and distributing component, which completes a throttling operation while distributing a refrigerant, thus eliminating the phenomenon of uneven distribution of the refrigerant. Another objective of the present invention is to provide a refrigerating system.

The objectives of the present invention are implemented with the following technical solutions:

A throttling and distributing component, including:

a main body extending from a first end to a second end, wherein a fluid enters the main body from the first end;

a regulator having a valve rod, wherein the valve rod passes through the second end and extends into the main body;

one or more openings disposed on a sidewall of the main body, each opening being in fluid communication with a plurality of branches extending from the main body respectively; and

a piston attached to the valve rod,

wherein the regulator is configured to adjust the position of the piston in the main body by using the valve rod, so as to selectively cover at least a part of each opening.

Optionally, the regulator is a stepper motor.

Optionally, the opening is disposed near the second end.

Optionally, downstream parts of the plurality of branches extend in parallel relative to the main body, and upstream parts of the plurality of branches extend perpendicularly from the main body.

Optionally, the opening is a rectangular opening.

Optionally, the opening has an oval or circular shape.

Optionally, the opening has a hyperbolic or parabolic shape.

Optionally, the piston and the main body jointly define a cavity, the cavity being configured to receive a refrigerant that keeps in a liquid state in the cavity.

Optionally, in a process that the refrigerant enters the branch through the opening, at least a part of the refrigerant is gasified into a gaseous state, such that the refrigerant entering the branch keeps in two phases of gas and liquid.

A refrigerating system, including:

a condenser;

the throttling and distributing component as described above, located downstream of the condenser, wherein an output end of the condenser is in fluid communication with the first end of the main body;

a plurality of evaporators or a plurality of evaporator passages located downstream of the throttling and distributing component and in fluid communication with the plurality of branches; and

a controller electrically connected to the regulator and configured to adjust the position of the piston by using the regulator.

The throttling and distributing component and the system of the present invention are advantageous in simple structures, reliable running and so on, and can complete a throttling operation while distributing a refrigerant.

### BRIEF DESCRIPTION OF THE DRAWINGS

The present invention will be described below in further detail with reference to accompanying drawings and preferred embodiments. However, those skilled in the art will understand that these accompanying drawings are merely drawn for explaining the preferred embodiments, and therefore should not be construed as limitations to the scope of the present invention. In addition, unless specified otherwise, the accompanying drawings are merely intended to conceptually represent composition or construction of a described object and may include exaggerated display. Moreover, the accompanying drawings are not necessarily drawn proportionally.

FIG. 1 is a schematic structural diagram of an embodiment of a throttling and distributing component according to the present invention.

FIG. 2 is a schematic partial cross-sectional diagram of the embodiment shown in FIG. 1.

### DETAILED DESCRIPTION

Preferred embodiments of the present invention will be described below in detail with reference to the accompanying drawings. Those skilled in the art will understand that these descriptions are merely descriptive and exemplary, and should not be construed as limitations to the protection scope of the present invention.

First, it should be noted that orientation terms such as top, bottom, upward, and downward mentioned in the text are defined with respect to directions in the accompanying drawings, and they are relative conceptions and thus can very according to their different positions and different use states. Therefore, these or other orientation terms should not be construed as limitative terms.

Moreover, it should be further noted that, for a random single technical feature described or implied in the embodiments of the text or a random single technical feature shown or implied in the accompanying drawings, these technical features (or their equivalents) can still be combined to acquire other embodiments of the present invention that are not directly mentioned in the text.

It should be noted that, in different accompanying drawings, identical reference numerals represent identical or substantially identical components.

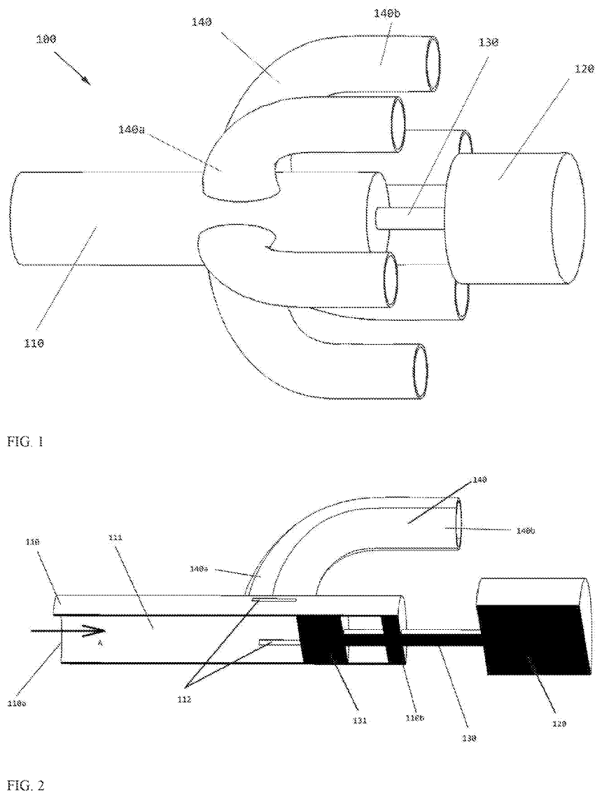

FIG. 1 is a schematic structural diagram of an embodiment of a throttling and distributing component according to the present invention. The throttling and distributing component 100 includes a main body 110; a regulator 120 disposed at one end of the main body 110 and provided with a valve rod 130, wherein the valve rod 130 extends into the main body 110; and a plurality of branches 140 extending out of the main body 110.

Optionally, the regulator 120 is a stepper motor.

Optionally, upstream parts 140a of the plurality of branches 140 extend perpendicularly from the main body 110.

Optionally, downstream parts 140b of the plurality of branches 140 extend in parallel relative to the main body 110.

FIG. 2 is a schematic partial cross-sectional diagram of the embodiment shown in FIG. 1. The main body 110 extends from a first end 110a to a second end 110b, wherein a fluid enters the main body 110 from the first end 110a, and the valve rod 130 passes through the second end 110b and extends into the main body 110. A piston 131 is disposed in the main body 110 and attached to the valve rod 130, wherein the piston 131 and the main body 110 jointly define a cavity 111.

As shown in the figure, one or more openings 112 are disposed on a sidewall of the main body 110, each opening 112 being in fluid communication with a plurality of branches 140 respectively. The regulator 120 is configured to adjust the position of the piston 131 by using the valve rod 130, so as to selectively cover at least a part of each opening 112.

Optionally, the opening 112 is a rectangular opening, such that the flux of a refrigerant entering each branch 140 can be adjusted by regulating the position of the piston.

Optionally, the opening 112 has an oval or circular shape.

Optionally, the opening 112 has a hyperbolic or parabolic shape.

Optionally, the opening 112 is disposed near the second end 110b.

In use, a liquid refrigerant from a condenser enters the cavity 111 from the first end 110a of the main body 110 in a direction indicated by an arrow A. A regulator 120 receives a control signal from a control system that is not shown, and operates the valve rod 130 according to the control signal to dispose the piston 131 in a desired position. The piston 131 selectively covers a part of each opening 112, so as to adjust the flux of the refrigerant entering the branch 140 from each opening 112.

Optionally, the piston 131 is configured to be completely spaced apart from each opening 112.

Optionally, the cavity 111 is configured to receive the refrigerant, and the refrigerant keeps in a liquid state in the cavity 111.

Optionally, in a process that the refrigerant enters the branch 140 through the opening 112, at least a part of the refrigerant is gasified into a gaseous state, such that the refrigerant entering the branch 140 keeps in two phases of gas and liquid.

Optionally, the downstream of each branch 140 is connected to a plurality of evaporators or a plurality of evaporator passages that are not shown.

The present invention further includes a refrigerating system, including:

a condenser located upstream of the refrigerating system;

the throttling and distributing component 100 as described above, located downstream of the condenser, wherein an output end of the condenser is in fluid communication with the first end 110a of the main body 110;

a plurality of evaporators or a plurality of evaporator passages that are not shown, located downstream of the throttling and distributing component 100 and in fluid communication with the plurality of branches 140; and

a controller electrically connected to the regulator 120 and configured to adjust the position of the piston 131 by using the regulator 120.

The throttling and distributing component and the refrigerating system of the present invention can adjust distribution of a refrigerant by adjusting a position of a piston 131, thus having advantages such as simple structures and reliable running and being capable of completing a throttling operation while distributing the refrigerant.

The present invention is disclosed with reference to the accompanying drawings of the specification. Moreover, those skilled in the art are enabled to implement the present invention, including manufacturing and using any apparatus or system, selecting appropriate materials, and using any combined methods. The scope of the present invention is limited by the technical solutions for which protection is sought, and includes other examples conceived by those skilled in the art. Other examples should be considered as falling within the protection scope determined by the technical solution claimed in the present invention as long as the other examples include structural elements not different from literal languages of the technical solution for which protection is sought or the other examples include equivalent structural elements not essentially different from literal languages of the technical solution for which protection is sought.

1. A throttling and distributing component, comprising:
a main body extending from a first end to a second end, wherein a fluid enters the main body from the first end;
a regulator having a valve rod, wherein the valve rod passes through the second end and extends into the main body;
one or more openings disposed on a sidewall of the main body, each opening being in fluid communication with a plurality of branches extending from the main body respectively; and
a piston attached to the valve rod,
wherein the regulator is configured to adjust the position of the piston in the main body by using the valve rod, so as to selectively cover at least a part of each opening.

2. The throttling and distributing component according to claim 1, wherein the regulator is a stepper motor.

3. The throttling and distributing component according to claim 1, wherein the opening is disposed near the second end.

4. The throttling and distributing component according to claim 3, wherein downstream parts of the plurality of branches extend in parallel relative to the main body, and upstream parts of the plurality of branches extend perpendicularly from the main body.

5. The throttling and distributing component according to claim 4, wherein the opening is a rectangular opening.

6. The throttling and distributing component according to claim 1, wherein the opening has an oval or circular shape.

7. The throttling and distributing component according to claim 1, wherein the opening has a hyperbolic or parabolic shape.

8. The throttling and distributing component according to claim 1, wherein the piston and the main body jointly define a cavity, the cavity being configured to receive a refrigerant that keeps in a liquid state in the cavity.

9. The throttling and distributing component according to claim 8, wherein in a process that the refrigerant enters the branch through the opening, at least a part of the refrigerant is gasified into a gaseous state, such that the refrigerant entering the branch keeps in two phases of gas and liquid.

10. A refrigerating system, comprising:
a condenser;
the throttling and distributing component according to claim 1 located downstream of the condenser, wherein an output end of the condenser is in fluid communication with the first end of the main body;
a plurality of evaporators or a plurality of evaporator passages located downstream of the throttling and distributing component and in fluid communication with the plurality of branches; and
a controller electrically connected to the regulator and configured to adjust the position of the piston by using the regulator.
